(19) United States
(12) Patent Application Publication
(10) Pub. No.: US 2026/0233634 A1
(43) Pub. Date: Aug. 13, 2026

(54) ELECTRIC BUS BATTERY INTERCHANGE SYSTEM AND METHOD

(71) Applicant: NEW FLYER INDUSTRIES CANADA ULC, Winnipeg (CA)

(72) Inventors: Robert Brydon Thomas OWEN, Winnipeg (CA); Kirk Stephane BURCAR, East St. Paul (CA)

(21) Appl. No.: 19/161,188

(22) PCT Filed: Feb. 29, 2024
(86) PCT No.: PCT/IB2024/051970

§ 371 Date: Aug. 29, 2025

Related U.S. Application Data
(60) Provisional application No. 63/461,612, filed on Apr. 25, 2023.

(51) Int. Cl. B60L 58/22; B60L 53/80; B60L 58/12; B60L 58/16; B60L 58/24; B60S 5/06; H01M 10/42; H01M 10/63

(52) U.S. Cl. CPC B60L 58/22; B60L 53/80; B60L 58/12; B60L 58/16; B60L 58/24; B60S 5/06; H01M 10/4207; H01M 10/63; B60L 2200/18; H01M 2220/20

(57) ABSTRACT

The present specification provides an electric bus battery interchange system, method and apparatus. A switching module seamlessly intermediates between a vehicle controller and a plurality of energy storage systems (ESS). A portion of the energy storage systems can be replaced while the switching module generates signals to the vehicle controller that are transparent to the vehicle controller.

### CROSS-REFERENCE TO RELATED APPLICATION(S)

This application claims the benefit of U.S. Provisional Patent Application No. 63/461612, filed Apr. 25, 2023, entitled “ELECTRIC BUS BATTERY INTERCHANGE SYSTEM AND METHOD”, the entire contents of each of which are incorporated herein by reference.

### BACKGROUND

Electric buses are an important step towards the goal of a low-carbon society. The transition from fossil fuel vehicles to electric vehicles has been and continues to be long and challenging. A significant barrier has been the technology to provide stable battery technologies that can store enough energy to power a large electric bus for substantially equivalent ranges as conventional fossil fuel buses. Fleets of electric buses are now beginning to enter service, as lithium-based batteries have proven a viable means for energy storage. However, lithium batteries can pose significant fire hazards and need to have sophisticated custom electronics and control systems in order to fit the form-factor of the bus and to properly interface with the bus's electric powertrain. These and other challenges continue to present a barrier to adoption of electric buses.

### SUMMARY

An aspect of the specification provides a method for controlling an electric bus or coach including: receiving a battery inventory of each of a plurality of heterogenous battery units; receiving a bus electricity demand parameters; determining a power profile based on the inventory and the parameters; drawing different electricity profiles from different ones of the battery units; generating the power profile by normalizing the different electricity profiles; managing battery thermal management control across each plurality of battery units; managing sequencing of the plurality of batteries during both driving and charging modes and, driving the powertrain of the bus according to the power profile.

An aspect of the specification provides a method wherein the heterogenous battery units are grouped into segments of substantially homogenous battery units.

An aspect of the specification provides a method wherein the substantially homogenous battery units are within range of a percentage of capacity.

An aspect of the specification provides a method wherein the percentage of capacity is between about zero percent and about five percent.

An aspect of the specification provides a method wherein the percentage of capacity is between about one percent and about four percent.

An aspect of the specification provides a method wherein the percentage of capacity is between about two percent and about three percent.

An aspect of the specification provides a method wherein there are two heterogeneous segments.

An aspect of the specification provides a method wherein the first segment has about 100 percent capacity and a second segment has less than about 95 percent capacity.

An aspect of the specification provides a method wherein the first segment and the second segment have about ten percent difference in capacity.

An aspect of the specification provides a method wherein the heterogenous battery units include a first segment at full life and a second segment at half life.

An aspect of the specification provides a method wherein the heterogenous battery units can be replaced and the battery inventory is refreshed when the battery units are replaced.

An aspect of the specification provides a controller for power and cooling management on an electric bus including a processor configured to: receive a battery inventory of each of a plurality of heterogenous battery units; receive a bus electricity demand parameters; determine a power profile based on the inventory and the parameters; draw different electricity profiles from different ones of the battery units; generate the power profile by normalizing the different electricity profiles; manage battery thermal management control across each plurality of battery units; manage sequencing of the plurality of batteries during both driving and charging modes and, drive the powertrain of the bus according to the power profile.

An aspect of the specification provides a controller wherein the substantially homogenous battery units are within range of a percentage of capacity.

An aspect of the specification provides a controller wherein the percentage of capacity is between about zero percent and about five percent.

An aspect of the specification provides a controller wherein the percentage of capacity is between about one percent and about four percent.

An aspect of the specification provides a controller wherein the percentage of capacity is between about two percent and about three percent.

An aspect of the specification provides a controller wherein there are two segments.

An aspect of the specification provides a controller wherein the first segment has about 100 percent capacity and a second segment has less than about 95 percent capacity.

An aspect of the specification provides a controller wherein the first segment and the second segment have about ten percent difference in capacity.

An aspect of the specification provides a controller wherein the heterogenous battery units include a first segment at full life and a second segment at half life.

An aspect of the present specification provides a method for implementing and releasing a switching-based architecture to allow groupings of ESS strings of alternate vendor cell types to co-exist on the same vehicle while remaining isolated from each other. In effect, onboard strings are divided into smaller segment groupings with supplementary switched sequencing, and then control schemes can be used that would allow connection of one grouping of strings at a time, wait until the strings are fully discharged, and then seamlessly switch over to the other grouping of strings to allow for continued discharging and operation of the vehicle while mitigating the compatibility challenges that exist between different battery cell versions from different suppliers.

### BRIEF DESCRIPTION OF THE FIGURES

FIG. 1 is a perspective view of the chassis and power supply system of an electric bus.

FIG. 2 shows one of the energy storage subsystems of FIG. 1 in greater detail.

FIG. 3 shows a schematic diagram of the power supply system of FIG. 1

FIG. 4 shows a flow chart showing a method of power control for an electric bus.

FIG. 5 shows a variant of the power supply system of FIG. 3.

FIG. 6 shows a flowchart showing another method of power control for an electric bus.

### DETAILED DESCRIPTION

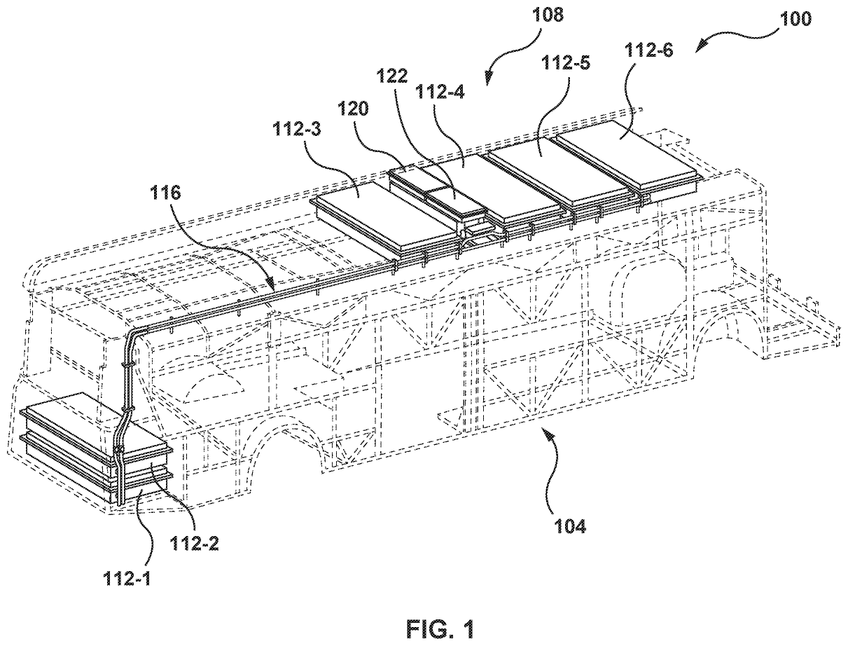

FIG. 1 shows a portion of an electric bus 100 in the form of a bus chassis 104 (shown in dotted lines) and a power supply system 108 (shown in solid lines). Power supply system 108 comprises a plurality of energy storage sub-systems 112-1, 112-2, 112-3, 112-4, 112-5, 112-6. (Collectively, energy storage sub-systems 112-1, 112-2 . . . 112-n are referred to as energy storage sub-systems 112 or ESSs 112, and generically, as energy storage system 112 or ESS 112. This nomenclature is used elsewhere herein.) Power supply system 108 also comprises a cooling subsystem 116 and at least one vehicle controller 120 and a switching module 122.

It is to be understood that the form factor of electric bus 100 is non-limiting and the locations, number and sizes and other form factor variables for the above-mentioned components can be vary across different types of buses which can benefit from the teachings of the present specification. Furthermore, while not shown in FIG. 1, bus 100 also includes a powertrain in the form of one or more electric motors that drive one or more the wheels of the bus. It is contemplated that the powertrain can vary across different buses that are variants of bus 100. Vehicle controller 120 is thus configured to regulate the transfer of energy from ESSs 112 to the powertrain according to the control signals issued from the accelerator and brake as operated by the driver, and other sensors on the bus such as global positioning system (GPS), cameras and lidar that can be directed to, for example, automatically applying brakes to the bus 100 in the event a hazard is detected. Controller 120 can also be configured to control regenerative braking thereby directing energy back into the ESSs 112. Controller 120 can also be configured to connect bus 100 to an external power supply to charge ESSs 112.

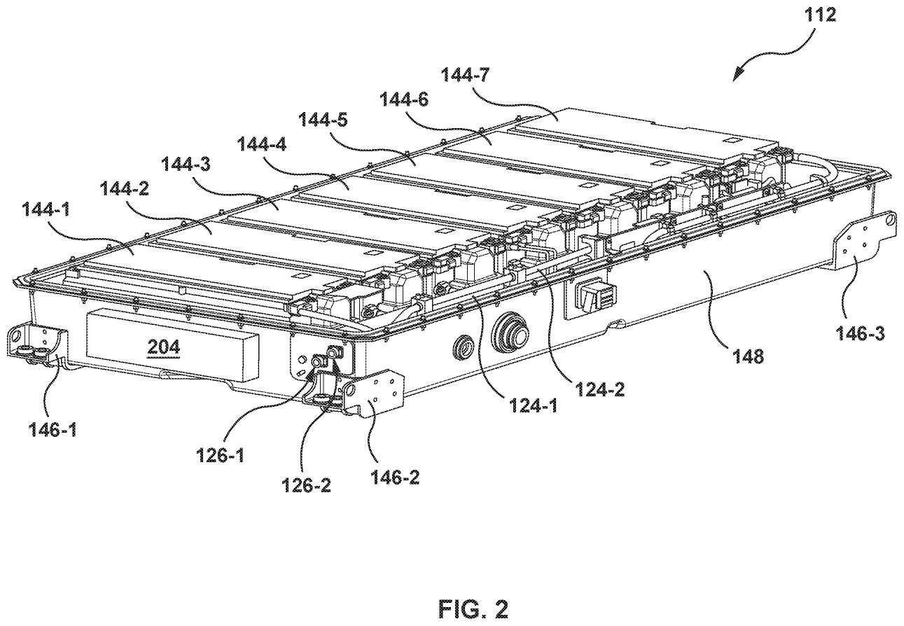

FIG. 2 shows an example of the interior of an example ESS 112 in greater detail. In FIG. 2, ESS 112 comprises a seven battery cells 144, which are in the present example are lithium-ion. Coolant lines 124 are shown as passing through the interior of ESS 112, with coolant ports 126 on a casing 148. (Coolant ports 126 comprise an inlet coolant port 126-1 and an outlet coolant port 126-2 respective to each line 124). Mounting brackets 146 are disposed on each corner of the casing 148 for securely mounting ESS 112 to chassis 104.

In FIG. 2, ESS 112 also includes a battery control unit 204 that cooperates with vehicle controller 120 and module 122 to monitor overall battery health, including charging, discharging, temperature. Battery control unit 204 can also moderate or control charging and discharging rates according to pre-defined safe operating parameters, and can also moderate or control temperature through management of coolant flow through coolant lines 124. Battery control units 204 can also include emergency shut off functions, in the event any safety parameter is violated such as overheating or fire. Thus, battery control units 204 can be integral with each ESS 112 and include one or more override switches, temperature sensors, voltage sensors, current sensors, charge level sensors, current modulators, voltage modulators, and coolant flow regulators.

FIG. 2 shows an example form factor for ESS 112 but it is to be understood that the present specification contemplates different form factors. For example, the form factor for ESS 112, the cells 144 and coolant lines 124, can vary across bus 100 or across different variations of bus 100. Furthermore, the contents of a given casing 148 for a given ESS 112 can vary, with different configurations, types, and numbers of cells 144 being included. Or, the cells 144 across different ESSs 112 can be the same type, but at different stages in their life-cycle. Overall, according to the present specification, a heterogenous or hybrid combination of ESSs 112 can be installed in bus 100 and/or across a fleet of buses.

As seen in FIG. 1, the power system 108 of bus 100 also includes at least one vehicle controller 120. Vehicle controller 120 can be based on any standard or known control device (or a plurality of devices) used for delivering energy from power system 108 to drive bus 100, such as sending electrical energy to the powertrain, and to accessories such as lighting systems; environmental controls such as heating, ventilation and air-conditioning; door control; and lighting. Vehicle controller 120 can also moderate charging of ESSs 112.

Notably, however, switching module 122 sits between controller 120 and ESSs 112. Switching module 122 manages ESSs 112 transparently on behalf of controller 120, responding to the power demand by controller 120 and power supply from controller 120. Switching module 122 is thus configured so that ESSs 112 are agnostic to controller 120. Switching module 122 “appears” to be ESSs 112 to controller 120, and switching module 122 “appears” to be controller 120 to ESSs 112.

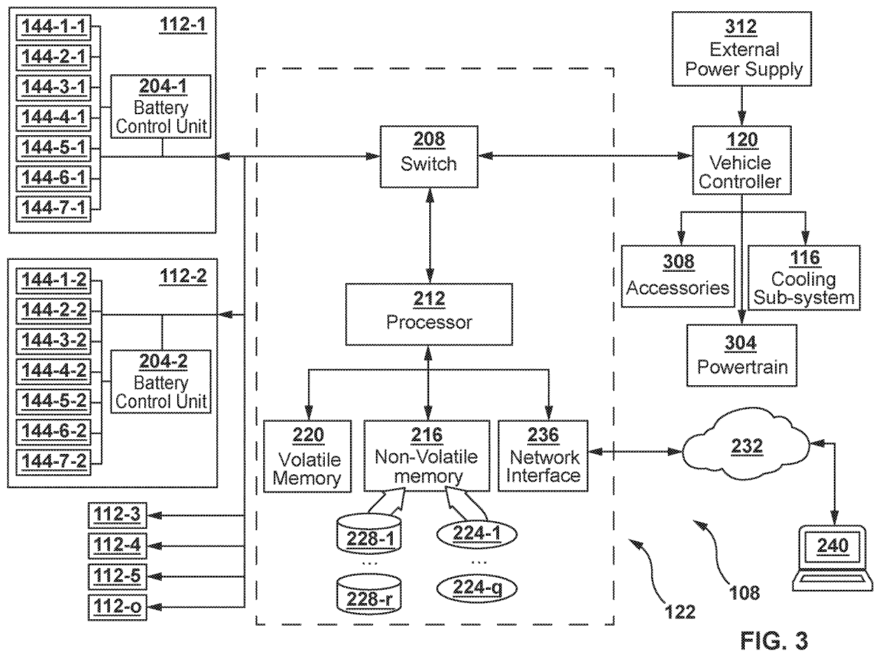

FIG. 3 is a schematic diagram showing power supply system 108 in greater detail, including a block diagram of a non-limiting example of switching module 122. Module 122 includes a switch 208 that connects to each ESS 112, to manage power exchange with cells 144 and to effect control signal communication with battery control units 204. (ESS 112-1 and ESS-2 are shown in greater detail than the remainder of ESSs for illustrative simplification.) While “o” ESSs 112 are shown in FIG. 3, and only six ESSs 112 are shown in FIG. 1, it is to be understood that switching module 122 can be configured to accommodate at least an equivalent number of ESSs 112 that are included in the standard form factor of bus 100. Switching module 122 can also be configured to also accommodate a different number of ESSs 112 than were included with the original design and manufacture of bus 100. Accordingly, bus 100 can be retrofitted with additional ESSs 112, or certain ESSs 112 can be removed, and module 122 is configured to accommodate such changes in the overall number of ESSs 112 while still permitting operation of the bus 100 if the overall amount of energy available from ESSs 112 is sufficient.

Switch 208 also connects to vehicle controller 120, which in turn connects to the bus's powertrain 304 and accessories 308. Vehicle controller 120 can also connect to an external power supply 312 to fulfill a charging cycle of ESSs 112, as moderated by vehicle controller 120 and module 122. Vehicle controller 120 can also connect to cooling subsystem 116, cooperating with each battery control unit via module 122, in order to direct coolant through lines 124 of each ESS 112, as needed to regulate temperature of each ESS 112, according the temperature profile of each ESS 112.

Switch 208 exchanges control signals with a processor 212 and is under the control of processor 212. Processor 212 may be implemented as a plurality of processors or one or more multi-core processors. The processor 212 may be configured to execute different programing instructions responsive to the conditions of the one or more battery control units 204 and the demands of vehicle controller 120. Switch 208 thus includes high-voltage power switching circuitry that is controlled by processor 212, for directing power between ESSs 112 and vehicle controller 120. Furthermore, switch 208 carries communication signals between battery control units 204 and processor 212, as well as communication signals between vehicle controller 120 and processor 212.

Note that, in certain prior art electric buses, module 122 can be omitted altogether, such that vehicle controller 120 can communicate directly with battery control units 204. In these prior art buses, module 122 can thus be retrofitted into such a prior art bus. Accordingly, module 122 intermediates between vehicle controller 120 and battery control units 204, such that communication signals and protocols between module 122 and controller 120 are the same communication signals and protocols that would normally occur directly between controller 120 and battery control units 204. By the same token, communications signals between module 122 and battery control units 204 are the same communication signals and protocols that would normally occur directly between battery control units 204 and controller 120. In simpler terms, module 122 emulates the control signals of battery control units 204 during communications with controller 120; and module 122 emulates the signals controller 120 during communications with battery control units 204.

In other embodiments, module 122 can be incorporated directly into a newer bus, intermediating between vehicle controller 120 and battery control units 204.

Switch 208 is under the control of the processor 212, which is configured to communicate with one or more memory units, including non-volatile memory 216 and volatile memory 220. Non-volatile memory 216 can be based on any persistent memory technology, such as an Erasable Electronic Programmable Read Only Memory (“EEPROM”), flash memory, solid-state hard disk (SSD), other type of hard-disk, or combinations of them. More than one type of non-volatile memory 216 may be provided. Non-volatile memory 216 can be described as a non-transitory computer readable media.

Volatile memory 220 is based on any random access memory (RAM) technology. For example, volatile memory 220 can be based on a Double Data Rate (DDR) Synchronous Dynamic Random-Access Memory (SDRAM). Other types of volatile memory 220 are contemplated.

Programming instructions in the form of applications 224 are typically maintained, persistently, in non-volatile memory 216 and used by the processor 212 which reads from and writes to volatile memory 220 during the execution of applications 224. One or more tables or databases 228 can also be maintained in non-volatile memory 216 for use by applications 224.

Processor 212 can also connect to a network 232 via a network interface 236 which includes a buffer and a modulator/demodulator or MODEM. Network 232 can thus be a wired bus that terminates in a port that accommodates a combined input/output device in the form of a diagnostic computer. Network interface 236 can also include a wireless radio, so that network 232 can also be more expansive to include access to the Internet, wired or wirelessly, thereby allowing module 122 to be accessed via computing device 240 from a remote location, and to upload diagnostic logs obtained by processor 212 and to download updates to applications 224 in non-volatile memory 216, and download updates to databases 228 in non-volatile storage.

Module 122 can be implemented using a programmable logic controller (PLC) or variant thereon, however the specific type of controller or implementation is not particularly limited.

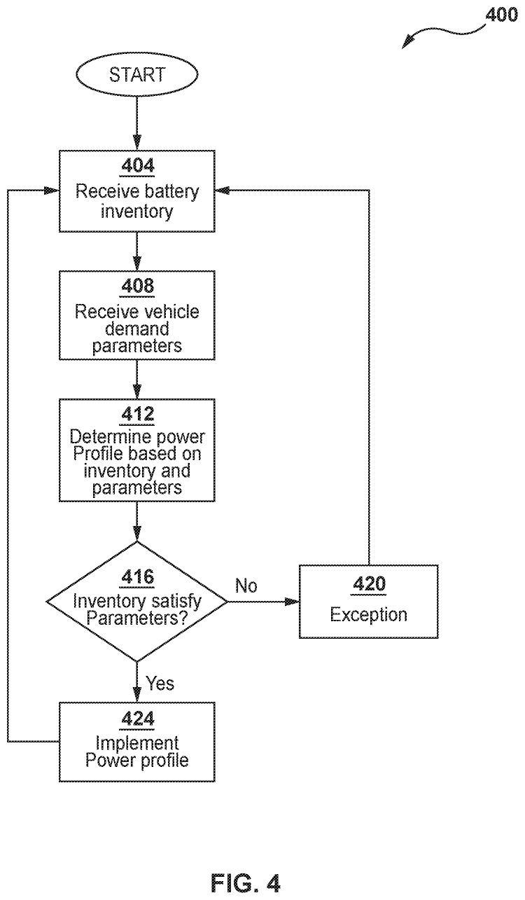

FIG. 4 shows a flowchart depicting a method for power control of an electric bus indicated generally at 400. Method 400 can be implemented on module 122 of bus 100. Method 400 can be stored as code within non-volatile memory 216 as one or more applications 224. Persons skilled in the art may choose to implement method 400 on bus 100 or variants thereon, or with certain blocks omitted, performed in parallel or in a different order than shown. Method 400 can thus be varied. However, for purposes of explanation, method 400 will be described in relation to its performance on bus 100.

Block 404 comprises receiving battery inventory. In the example of bus 100, block 404 is implemented by processor 212 which communicates with each battery control unit 204. The query includes all relevant states of each ESS 112, including current charge level and temperature. The query can also include verification of the manufacturer specifications of each ESS 112, including make, model, age and known charge rates, discharge rates and safe-temperature profiles. The specifications can be stored in databases 228, and periodically updated via network 232.

Block 408 comprises receiving vehicle demand parameters. In the example of bus 100, block 408 is implemented by processor which communicates with vehicle controller 120 to receive what power demands are being drawn from powertrain 304 and/or accessories 308, and/or what power is being provided by external power 312. As a simple example, if bus 100 is being driven along its current route, then powertrain 304 is seeking to draw sufficient energy from ESSs 112 to drive the powertrain 304 and related accessories 308. As another example, if bus 100 is parked in a storage garage with powertrain 304 and accessories 308 deactivated, and external power 312 is connected to controller 120, then the received demand parameters include a demand to supply power to ESSs 112 to boost the amount of stored energy within them. Block 408 thus generally contemplates all of the normal operations of bus 100 in terms of drawing power from ESSs 112 or supplying power to ESSs 112.

Block 412 comprises determining a power profile based on the inventory from block 404 and the demand parameters from block 408. In a prior art bus, ESSs 112 are homogenous, designed to be incorporated into the bus such that they seamlessly cooperate with vehicle controller 120 to fulfill the energy demands of the powertrain and accessories, and to respond to the energy storage functions when connected to external power. When module 112 is incorporated into such a prior art bus, block 412 results in the same overall behavior of the prior art bus control systems between the vehicle controller and the ESSs. However, according to the present specification, it is contemplated that ESSs 112 may be heterogeneous. More particularly, in bus 100, some, or all, of ESSs 112 that were originally manufactured with bus 100 can be replaced with different ESSs 112 that need not comply with original equipment manufacturer (“OEM”) specifications. For example, assume that ESS 112-1 and ESS 112-2 are original from the time that bus 100 was manufactured, and are considered to be at “Full-Life” and also assume that ESS 112-3 and ESS 112-4 are taken from a different bus and are considered to be at “Mid-Life”. Accordingly, the power profile determined at block 412 can be based on drawing different available amounts of power from different ESSs 112.

Block 416 comprises determining if the inventory from block 404 can satisfy the parameters from block 408. Block 416 can thus be based on the power profile from block 412 to ascertain whether the operation of bus 100 according to the demand parameters from block 408 is possible. A “no” determination at block 416 leads to block 420 for exception handling. A “yes” determination at block 416 leads to block 424 where the power profile from block 412 is implemented, and power is transferred between vehicle controller 120 and ESSs 112 (via switch 208 and control units 204) according to the profile determined at block 412. Block 424 returns to block 404 and the method repeats.

The nature of exception handling at block 420 is not particularly limited. For example, bus 100 can be prevented from operating and/or an error message can be generated on a device 240 or on the dashboard of bus 100 indicating that the current conditions of ESSs 112 do not permit operation of the bus.

It is to be recognized that method 400 can also be used for a charging sequence. Block 404 comprises receiving the different battery profiles including the level of depletion. Block 408 comprises determining vehicle demand parameters in the form of how much electricity is available from external power supply 312. Block 412 comprises determining a power profile based on the inventory and the requirements. More specifically, each of the ESSs 112 may have heterogeneous levels of depletion, temperatures, and potential charge rates. Block 416 is typically satisfied as long as at least one of the ESSs 112 is capable of accepting a charge and sufficient electricity is available from external power supply 312. Block 424 comprises drawing power from the power supply 312 and sending different charges to each ESS 112 according to the inventory from block 404.

In general terms, it is to be understood that, when operating bus 100, block 424 comprises processor 212 controlling switch 208 to draw power from each ESS 112 according to the availability of power and controlling the cooling functions to maintain each ESS 112 within safe operating parameters. Thus each ESS 112 is independent from the other and can be heterogenous, delivering different amounts of power and using different amounts of cooling according to the unique profile of each ESS 112. At the same time, processor 212 is configured to control switch 208 so as to “clean up” the aggregated power that is drawn from all of the ESSs 112, such that vehicle controller 120 receives a normalized and steady amount of power for distribution amongst accessories 308, powertrain 304, cooling subsystem 116 and any other power loads.

Conversely, when bus 100 is being charged, block 424 comprises processor 212 controlling switch 208 to deliver power to each ESS 112 according to the availability of power from external power supply 312. Since each ESS 112 is independent from the other and can be heterogenous, the charging of each ESS 112 can be according to the respective profile of each ESS 112. At the same time, processor 212 is configured to control switch 208 so as to “divide up”, the power that is drawn power supply 312 so that each ESS 112 can be charged uniquely according to the profile of each ESS 112.

The result is module 122 is configured to manage a plurality of heterogenous ESSs 112 in a fashion that is transparent to vehicle controller 120. ESSs 112 can be safely swapped or replaced with a broad possible range of inventory without any modifications to the bus, and can include ESSs 112 that are hybridized or heterogenous.

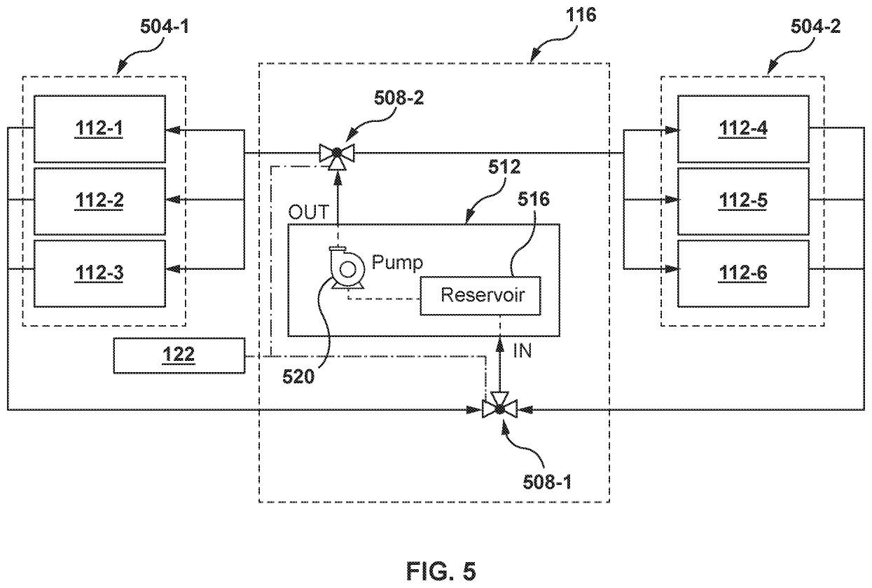

FIG. 5 shows one possible implementation of cooling subsystem 116. In FIG. 5, it is assumed that there are six ESSs 112, which are separated into two separate segments 504 of ESSs 112 with each with similar cooling requirements. Thus, in FIG. 5, ESS 112-1, ESS 112-2, and ESS 112-3 represent the first segment 504-1, and ESS 112-4, ESS 112-5, and ESS 112-6 represent the second segment 504-2. Additional segments 504 in variants are contemplated. The number of ESSs 112 per segment is not particularly limited. Cooling subsystem 116 is configured to manage coolant flow control that would be needed relative to battery thermal management of each segment 504. A pair of electrical 3-way variable valves 508 are provided to manage coolant flow between the segments 504. Valve 508-1 controls the inlet of coolant to a reservoir module 512 that includes a coolant reservoir 516 and a pump 520. Valve 508-2 controls the outlet of coolant from the module 512 and can selectively direct coolant to either segment 504 in varying proportions, thereby allowing flow independently across each battery segment 504. The actuators would be by controller 122 and allow for isolated coolant flow to be directed across each of battery segment 504. Accordingly, heterogenous battery segments 504 can be accommodated, with variable volumes and flow rates of coolant be directed to each segment 504 according to the individual needs of each segment. Doing this will allow for new battery segments with different cooling requirement volumes and capacity to be integrated into the vehicle without requiring mechanical changes to the cooling system. In effect, the subsystem 116 allows for an existing onboard battery coolant reservoir and thermal management system, sized appropriately, to be utilized as-is without needing to change size or capacity.

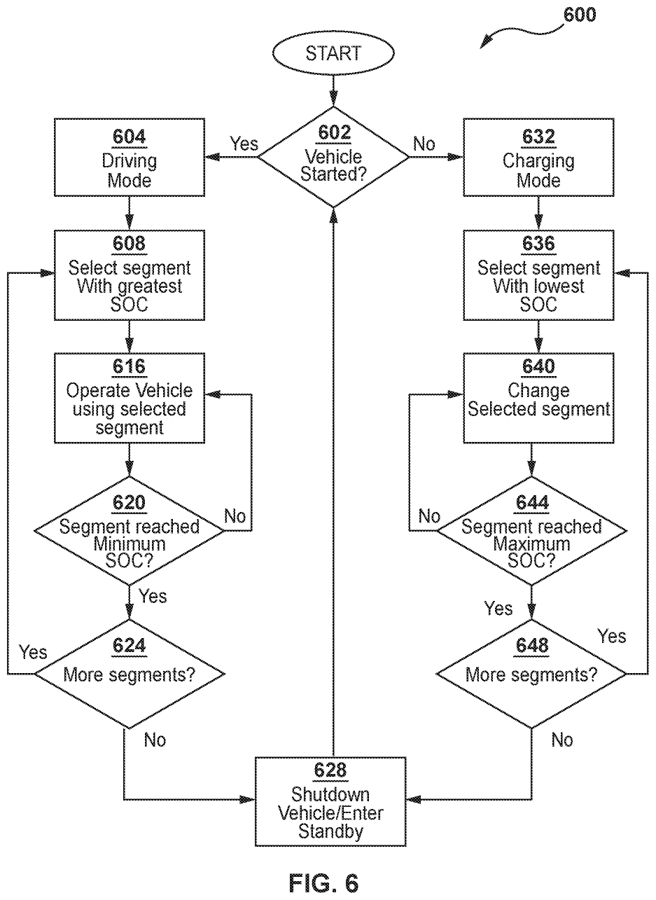

FIG. 6 shows a flowchart depicting a method for controlling the plurality of battery segment connection sequencing during both driving and charging applications. In this concept, when the vehicle is in drive mode, the controller would select the battery segment with the highest state-of-charge. Once connected, the vehicle would then drive on this segment until the battery segment reaches its minimum state of allowable charge. At that point, the proposed controller concept would then switch to the alternative battery segment seamlessly and allow vehicle to continue driving, until either vehicle is shutdown, or the second battery segment reached its minimum state of charge.

By the same token, when the vehicle is in charge mode, the controller would select the battery segment with the lowest state-of-charge. Once connected, the vehicle would then charge on this segment until the battery segment reaches its maximum state of allowable charge. At that point, the controller concept would then switch to the alternative battery segment seamlessly and allow vehicle to continue charging, until either vehicle is shutdown, or the second battery segment reached its charge completion.

Block 602 comprises determining if the vehicle has started. A “Yes” determination leads to block 604 a driving mode is effected while a “No” determination leads to block 632 where a charging mode is effected.

According to the driving mode branch from block 604, at block 608 the string grouping, or segment with the highest state of charge (SOC) is selected. Selection includes activating both the electrical power transfer from the ESSs 112 of the selected segment 504 to the powertrain 304, and activating cooling subsystem 116 to cool the selected segment 504. For example, in relation to FIG. 5, if segment 504-1 has a higher state of charge than segment 504-2, then segment 504-1 is selected for both electrical power transfer and for cooling functions. Such selection leads to that segment 504-1 thus being prioritized for vehicle operation over segment 504-2, and thus at block 616 according to this example, segment 504-1 is utilized for operating the vehicle. Block 620 comprises determining if a minimum state of charge of the selected segment from block 608 has reached a minimum state of charge. A “No” determination at block 620 loops method 600 back to block 616. A “yes” determination at block 620 leads to block 624 in which case a determination is made if there are more segments available for operating the vehicle. According to our example, assume that segment 504-1 has been depleted, but segment 504-2 remains available. Thus method 600 will have a “yes” determination at block 624 and method 600 cycles back to block 608 at which point there is a switchover in from segment 504-1 to segment 504-2 in terms of provision of power to powertrain 304 and activation of cooling via cooling subsystem 116. A “no” determination at block 624 leads to block 628 at which point the vehicle shuts down and/or enters a standby mode, and method 600 returns to block 602.

As mentioned, the “no” determination at block 602 leads to block 632 at which point the vehicle enters a charge mode. Block 636 comprises selecting the segment with the lowest state of charge and directing electrical power from external power supply 312 (assuming connected) to the selected segments 504. Cooling subsystem 116 is also activated appropriate to a charging cycle.

Charging continues at block 640 and periodic checks for state of charge occur at block 644. Once the segment selected at block 636 reaches the maximum state of charge, then a “yes” determination is made at block 644 and method 600 advances to block 648. If there are additional segments 504 to be charged, then method 600 cycles back to block 636 and the next segment with the lowest state of charge is selected, until no more segments 504 are noted as being available at block 648, and method 600 advances to block 628 as previously discussed.

Note that certain aspects of method 600 are idealized in that a vehicle may be put into charge mode at block 632 before all segments 504 are depleted as per block 620 and block 624. Conversely a vehicle may be put into driving mode per block 604 even if not all segments 504 have been fully charged. Also note that attempts to continue charging in charge mode at block 632 will simply lead to a rapid pass through to block 628 and continual loop if all segments 504 are already fully charged when block 636 is first reached.

In view of the above it will now be apparent that variants, subsets and combinations are contemplated. For example, method 600 contemplates more than just the two segments 504 shown in FIG. 5. It is contemplated that the teachings herein may be modified for other types of electric vehicles including motor coaches, trucks, light trucks, vans, and passenger cars.

It is to be understood that the various segments can be defined as being heterogenous based on the battery chemistry, manufacturer, model, materials and other variables. Different chemistries can involve changes to the anode, cathode and substrate composition of various cell generations from a first manufacturer, or could be a complete different Lithium-Ion NMC formulation from a different manufacturers. Or in the future, it could even mean completely different battery chemistry types that are not Nickel Manganese Cobalt (“NMC”) or Lithium-Ion base, either from existing vendors or new ones.

It is to be understood that the battery units of ESSs 112 can be described in terms of their capacity. To elaborate a “new” ESS 112 can have about 100 percent capacity, giving it the maximum amount of available power storage therefore the longest possible range for the bus. However, a “half life” ESS 112 can have between about 70 percent and 80 percent capacity, giving ESS 112 the maximum amount of available power storage therefore the only half the possible range for the bus as compared to a “news” ESS 112. The teachings herein, amongst other things, enable how segments 504 of ESS 112 can be grouped according to capacity and be mixed and matched.

Within a segment 504, battery units can be completely homogenous or substantially homogenous. Substantially homogenous battery units are within range of a percentage of capacity. For example, the percentage of capacity for segments of substantially homogenous units can be ESS12 having a difference in capacity of between about zero percent and about five percent. The percentage of capacity can be between about one percent and about four percent. The percentage of capacity can be between about two percent and about three percent.

Wherein there are two heterogeneous segments, the first segment can about 100 percent capacity and the second segment can have less than about 95 percent capacity. the first segment can about 100 percent capacity and the second segment can have less than about 90 percent capacity. the first segment can about 100 percent capacity and the second segment can have less than about 80 percent capacity. The two segments can have a difference in capacity of greater than about five percent capacity. The two segments can have a difference in capacity of greater than about seven percent capacity. The two segments can have a difference in capacity of greater than about ten percent capacity. The two segments can have a difference in capacity of greater than about fifteen percent capacity. The two segments can have a difference in capacity of greater than about twenty percent capacity.

The heterogenous battery units can include a first segment at full life and a second segment at half life.

The heterogenous battery units can be replaced and the battery inventory can be refreshed when the battery units are replaced.

Certain advantages according to the present specification will now occur to those skilled in the art. For example, flexible mid-life replacement of a portion of ESSs 112 is possible, allowing a remainder of functioning ESSs 112 to remain in service on bus 100. The present specification can also allow for any future battery type to be integrated with legacy batteries. The programmable nature of module 122 can permit for switching electronics and programming to allow for string hybridization. The present specification can allow for range boost on degraded capacity vehicles by increasing overall kWh capacity beyond “new”.

Additionally, electric buses with defective ESSs have greater flexibility for rapid retrofitting with different ESSs and thereby bring them back into service more quickly.

The present specification can also allow for the development of a new standard for battery management systems (BMS) and battery thermal management systems (BTMS) that allow for mixing and matching of different vendor cell types and generations based on knowledge of cell chemistry and mathematical models. As another example, where certain bus routes may only require, for example, half of the potential range of the bus, then module 112 can be configured to implement supplementary switched sequencing to stagger the use of each ESS 112 and prolong life. The reverse would occur during recharging of the batteries (depot or overhead).

It should be recognized that features and aspects of the various examples provided above can be combined into further examples that also fall within the scope of the present disclosure. In addition, the figures are not to scale and may have size and shape exaggerated for illustrative purposes.

1. A method for controlling an electric bus or coach comprising:
receiving a battery inventory of each of a plurality of heterogenous battery units;
receiving a bus electricity demand parameters;
determining a power profile based on the inventory and the parameters;
drawing different electricity profiles from different ones of the battery units;
generating the power profile by normalizing the different electricity profiles;
managing battery thermal management control across each plurality of battery units;
managing sequencing of the plurality of batteries during both driving and charging modes and,
driving the powertrain of the bus according to the power profile.

2. The method of claim 1 wherein the heterogenous battery units are grouped into segments of substantially homogenous battery units.

3. The method of claim 2 wherein the substantially homogenous battery units are within range of a percentage of capacity.

4. The method of claim 3 wherein the percentage of capacity is between about zero percent and about five percent.

5. The method of claim 3 wherein the percentage of capacity is between about one percent and about four percent.

6. The method of claim 3 wherein the percentage of capacity is between about two percent and about three percent.

7. The method of claim 1 wherein there are two heterogeneous segments.

8. The method of claim 7 wherein the first segment has about 100 percent capacity and a second segment has less than about 95 percent capacity.

9. The method of claim 7 wherein the first segment and the second segment have about ten percent difference in capacity.

10. The method of claim 7 wherein the heterogenous battery units include a first segment at full life and a second segment at half life.

11. The method of claim 1 wherein the heterogenous battery units can be replaced and the battery inventory is refreshed when the battery units are replaced.

12. A controller for power and cooling management on an electric bus comprising a processor configured to:
receive a battery inventory of each of a plurality of heterogenous battery units;
receive a bus electricity demand parameters;
determine a power profile based on the inventory and the parameters;
draw different electricity profiles from different ones of the battery units;
generate the power profile by normalizing the different electricity profiles;
manage battery thermal management control across each plurality of battery units;
manage sequencing of the plurality of batteries during both driving and charging modes and,
drive the powertrain of the bus according to the power profile.

13. The controller of claim 12 wherein the substantially homogenous battery units are within range of a percentage of capacity.

14. The controller of claim 13 wherein the percentage of capacity is between about zero percent and about five percent.

15. The controller of claim 13 wherein the percentage of capacity is between about one percent and about four percent.

16. The controller of claim 13 wherein the percentage of capacity is between about two percent and about three percent.

17. The controller of claim 12 wherein there are two segments.

18. The controller of claim 17 wherein the first segment has about 100 percent capacity and a second segment has less than about 95 percent capacity.

19. The controller of claim 17 wherein the first segment and the second segment have about ten percent difference in capacity.

20. The controller of claim 17 wherein the heterogenous battery units include a first segment at full life and a second segment at half life.
